(19) United States
(12) Patent Application Publication
(10) Pub. No.: US 2007/0204804 A1
(43) Pub. Date: Sep. 6, 2007

(54) GPS PET CONTAINMENT SYSTEM AND METHOD

(76) Inventors: Scott D. Swanson, Burnsville, MN (US); John B. Rydberg, Farmington, MN (US); Raymond P. Oberleitner, Eden Prairie, MN (US); Edward M. Watson, Madison, WI (US); David P. Mulcrone, Shakopee, MN (US); Bradley R. Leonard, Dennison, MN (US)

Correspondence Address: Kimberly K. Baxter;Baxter Law Office, 19013 Saint Edwards Court, Eden Prairie, MN, 55346, US

(21) Appl. No.: 11/538,021

(22) Filed: Oct. 2, 2006

Related U.S. Application Data
(60) Provisional application No. 60/722,802, filed on Sep. 30, 2005.
(60) Provisional application No. 60/729,164, filed on Oct. 21, 2005.

(51) Int. Cl. A01K 15/04

(52) U.S. Cl. 119/721

(57) ABSTRACT

Described herein is a GPS pet containment system is that generally self contained within a collar. However, the collar includes a battery power source, a microcontroller powered by the battery power source, a global positioning system (GPS) interfaced to the microcontroller and an accelerometer interfaced to the microcontroller. The GPS operates to provide collar location information on a periodic basis while the accelerometer provides collar dead reckoning location information on a substantially continuous basis. The dead reckoning location information is acquired by integrating the acceleration value provided by the accelerometer over sub-second time intervals.

### CLAIM TO PRIORITY

The present application claims priority to U.S. provisional patent application no. 60/722,802, filed Sep. 30, 2005 and to U.S. provisional patent application no. 60/729,164, filed Oct. 21, 2005. Each of the identified provisional patent applications is hereby incorporated by reference.

### FIELD OF THE INVENTION

The present invention relates to electronic animal containment systems and, more particularly to, a global positioning system (GPS) pet containment system.

### BACKGROUND OF THE INVENTION

Conventional and electric fencing is commonly used to control the location of animals. Barrier fencing, which physically blocks the movement of the animal, is most frequently used to confine both domestic pets and farm animals. Physical electric fencing, which uses an electric shock to discourage contact with the fence, is typically used to confine commercial livestock. The purpose of an electric fence is to keep farm animals within an area, or to prevent undesired animals from entering property. High voltage electrical impulses are applied to a “live” fence wire by an energizer. This impulse lasts only thousandths of a second but is repeated every second or so. An animal, which strays to contact with the live wire, completes a circuit between the live wire and the soil. The result is an electric shock sufficiently unpleasant to cause the animal to move rapidly away from the fence before the next electrical impulse. After a few encounters, animals learn not to touch the live wire or approach the fence too closely.

In its simplest form, an electric fence comprises a single live wire elevated above the earth by a suitable means of support and electrically insulated from the earth. This basic electric fence arrangement relies on moisture in the soil to act as a conductor of electricity from the animal back to the energizer. When an animal makes contact with the live wire, the electrical impulse is conducted through the muscles of the animal, down into its legs and into the soil and through the moisture in the soil back to the energizer. This completes the electrical circuit.

An important disadvantage of electric fencing is the labor-intensive installation of the fence, which, depending on acreage, can require anywhere from a few to hundreds of man-hours. Another disadvantage is the physical presence of the fence on the property, which presents an electrical shock hazard to humans and can be unattractive. In addition, the fencing relies on peripheral elements such as the moisture in the soil in order to be effective, and may be subject to damage over time from environmental factors.

Recently, hidden electronic fences have gained popularity. Hidden fences are not physical barriers; but instead psychological barriers. Once installed, the animal will understand from experience that it cannot pass through the barrier without being disciplined/corrected. A receiver on the animal's collar administers the correction. The correction is an electrical impulse similar to the impulse administered by the physical barrier fence. It is harmless yet is unpleasant enough that the animal will want to avoid the sensation in the future.

Installation of a hidden electronic fence involves burying a boundary wire around the perimeter of the property or whatever other area to which the user wants to restrict the animal's movement. Each end of the wire is then plugged into a transmitter. Once the transmitter is switched on, it generates a signal from the wire. This signal activates the dog's receiver whenever the dog comes close to the boundary wire. Activation of the receiver can trigger an audible sound to warn the animal, or if the animal is very close to the wire, an electrical shock.

An important disadvantage of hidden electronic fencing, similar to above-ground electric fencing, is the labor-intensive installation of the fence requiring trenching or other digging in order to install the boundary wire. Another disadvantage is that if the animal runs through the barrier, they have a distinct impediment to crossing that barrier again, as the receiver is indifferent to the animal's direction of travel. Such “run-through” is a common phenomenon with fast animals such as dogs, which may become distracted and violate the perimeter in an instant after being enticed by an attractive stimulus. For example, the dog's predatory instinct may be aroused by a nearby animal, causing them to chase the animal without regard to the pending correction. After such run-through, the animal is confused or in a state of panic because it has strayed from the defined area, and may even be receiving unpleasant stimuli, but is unsure how to proceed or otherwise does not respond to the stimuli as desired. They are trapped outside of the area they are supposed to be in but may be presented with a definite disincentive to return. For example, as they approach the defined property, a warning tone may sound at their receiver, or they may receive a correction. Finally, the setting and determination of the perimeter's boundaries can be complicated, for example, by driveways, and dependent upon a location to safely place the electrical wire.

Further advancements in the technology, which are able to determine the location of an object, have led to alternative means of animal control. The United States government has placed in operation a multiple-satellite global positioning system (“GPS”). A GPS receiver receives signals from multiple satellites in orbit, and calculates the position of the receiver based on the signal data. This method of location determination is well known.

Recently developed containment systems have attempted to take advantage of this GPS technology. For instance, U.S. Pat. No. 5,949,350, entitled “Location and Method Apparatus” describes a location and method apparatus related to the containment of an animal within a specified area. This apparatus requires the use of a reference unit and a mobile unit that are each capable of independently receiving a broadcast position indicating data signal, i.e., both the reference unit and the mobile unit include their own receivers. The combination of the reference unit and the mobile unit determine whether the mobile unit is within a predetermined boundary via the reference unit broadcasting a reference signal to the mobile unit (or, alternatively, by the mobile unit broadcasting a reference signal to the reference unit). The '350 patent indicates that its system is unable to operate without a reference signal due to the inaccuracies of the GPS signal.

### SUMMARY OF THE INVENTION

The disadvantages described above are large part addressed by the GPS pet containment system of the present invention. The GPS pet containment system is generally self contained within a collar. However, the collar includes a battery power source, a microcontroller powered by the battery power source, a global positioning system (GPS) interfaced to the microcontroller and an accelerometer interfaced to the microcontroller. The GPS operates to provide collar location information on a periodic basis while the accelerometer provides collar dead reckoning location information on a substantially continuous basis. The dead reckoning location information is acquired by integrating the acceleration value provided by the accelerometer over sub-second time intervals.

In an alternative embodiment, the GPS pet containment system of the present invention includes both a collar and a cradle. The collar includes a battery power source, a microcontroller powered by the battery power source, a global positioning system (GPS) interfaced to the microcontroller and an RF receiver/transmitter interfaced to the microcontroller. The cradle includes an RF receiver/transmitter that emits a signal to create an RF bubble about the collar. The RF bubble is defined by a signal strength that is detected by the collar's RF receiver/transmitter and, upon detecting that signal strength is strong, GPS tracking is ceased to conserve battery power.

In still another embodiment of the invention the GPS pet containment system utilizes a collar that includes a battery power source, a microcontroller powered by the battery power source, a global positioning system (GPS) interfaced to the microcontroller and an accelerometer interfaced to the microcontroller. In this embodiment, the GPS provides collar location information on a periodic basis while the accelerometer provides collar dead reckoning location information on a substantially continuous basis by integrating the acceleration value provided by the accelerometer over sub-second time intervals. This collar dead reckoning location information determines whether the collar is leaving a boundary or returning to a boundary. The collar delivers a shock to the wearer upon a determination of leaving the boundary.

In a preferred embodiment, the collar is made of a stainless steel band supporting at least two electronic housings that are connected by a flexwire. The electronic housings, the steel band, and the flexwire are overmolded to form a single unit. The overmolding is preferably performed with a saniprene material.

### DESCRIPTION OF THE DRAWINGS

FIG. 1 is a perspective view of the pet containment system of the present invention.

FIG. 2 depicts the pet collar component of the pet containment system.

FIG. 3 depicts the user interface portion of the pet collar that is provided with the electronics compartment of the pet collar.

FIG. 4 depicts the components of the recharge cradle of the pet containment system.

FIG. 5 is a block diagram depicting the electronic elements of the GPS compartment and the electronics compartment of the pet collar.

FIG. 6 is a flow chart for acquisition of current position.

FIG. 7 is a flow chart for the main loop of operation for the pet collar.

FIG. 8 is a collar state transition diagram.

FIG. 9 is a flow chart depicting the menu operations available to the user.

FIG. 10 is a flow chart for the function of Set Safe Zone.

FIG. 11 is a flow chart for the function of Synchronize Position.

FIG. 12 is a flow chart for the function of Create Boundary.

FIG. 13 is a flow chart for the collar state of Unknown Position.

FIG. 14 is a flow chart for the collar state of Out of Bounds.

FIG. 15 is a flow chart for the collar state of In Bounds

FIG. 16 is a flow chart for the collar state of In Safe Zone

FIG. 17 is a flow chart for the collar state of In Warning Zone.

FIG. 18 is a flow chart for the collar state of Sitting Still.

### DESCRIPTION OF THE PREFERRED EMBODIMENTS

The global positioning system (GPS) pet containment system of the present invention provides the user with a product that requires no buried wire, no on-going maintenance, no technical installation and no recurring battery purchase. Rather the GPS pet containment system provides the user with a portable system that is easily, and on-demand, programmed to define a pet containment area without coverage area limitations. Further the GPS pet containment system is contained within a single unit collar requiring no other components for operation except a battery recharger and through the use of an accelerometer is able to know the location at substantially all times rather than strictly relying on the second per second location data update provided by the GPS.

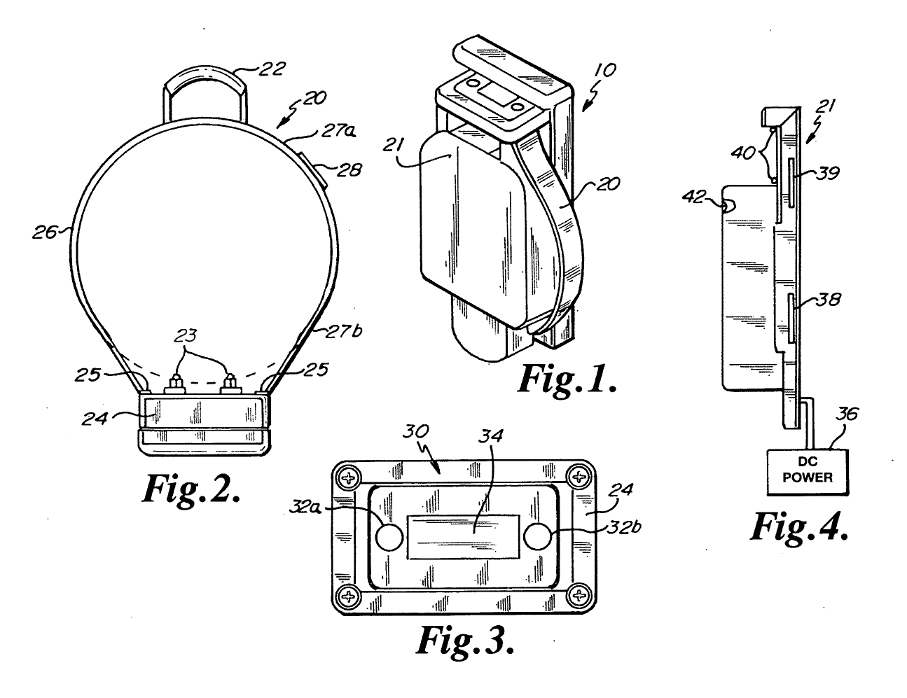

The GPS pet containment system 10 of the present invention is shown in FIGS. 1-4 and generally includes the components of a pet collar 20 and a recharge cradle 21. The pet collar 20 includes a GPS compartment 22 and an electronics compartment 24 with extending electrodes 23 and recharge contact points 25, while a stainless steel band supporting a flex cable, not shown, is overmolded with a material such as saniprene to create a neckband 26 connecting the two compartments. The saniprene presents the collar in a waterproof configuration and enable easy cleaning of the collar 20. Sections of webbing 27a and 27b, and snap connector 28, or other suitable connection means, connect the ends of the neckband 26 so that the collar 20 may be fit about the neck of a pet.

FIG. 3 details the user interface 30 presented by the electronics compartment 24 of the collar 20. Specifically, the user interface 30 includes two membrane switches 32a and 32b for toggling between menu options and an LCD screen 34 for displaying the menu to the user. FIG. 4 provides an internal view of the elements of the recharge cradle 21. The recharge cradle 21 includes a DC power supply connector 36, a GPS interface and a radio frequency (RF) receiver/transmitter 38, a magnet 39 for holding collar 20 and its recharge contact points 25 in position against a plurality of spring contacts 40 for recharge of the collar 20, and an LED 42 to indicate that the collar is recharging/has charged.

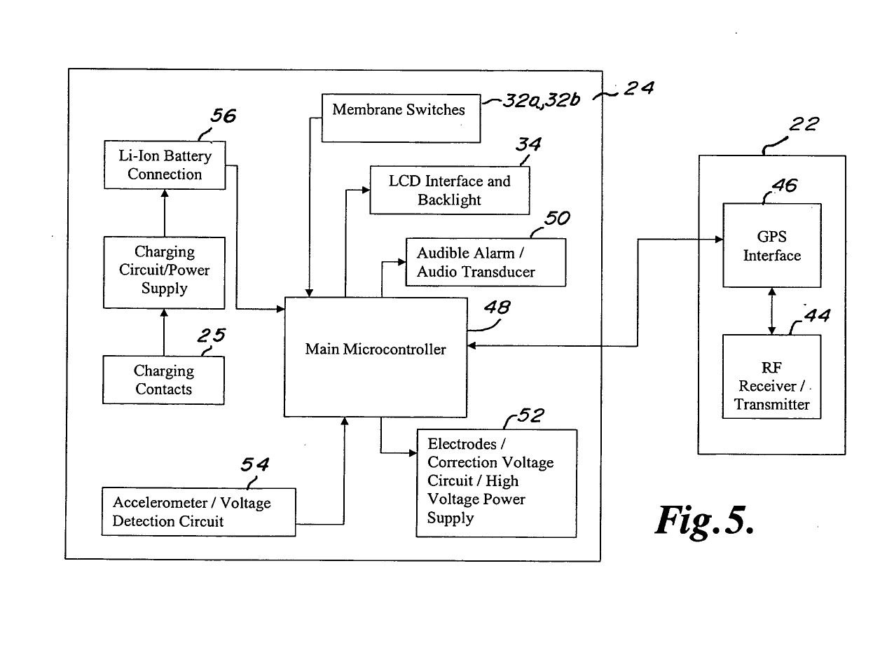

The GPS compartment 22 and the electronics compartment 24 of the collar 20 of the pet containment system 10 are detailed in the block diagram of FIG. 5. As shown, the GPS compartment 22 includes an RF receiver/transmitter 44 and an active antenna, single frequency GPS interface 46. The electronics compartment 24 incorporates the main microcontroller 48 that controls the operation of the collar 20. Further contained within the electronics compartment 24 and interfaced to the processor 48 are the user-interface, membrane switches 32a and 32b, and the LCD screen 34 as well as alarms, i.e., audible alarm 50 directed to the hearing of the pet and shock alarm 52 (correction of voltage circuit/high voltage power supply), delivered to the neck of the pet through the electrodes 23; different size electrodes may be selected depending on the size of the pet. An accelerometer 54 to detect motion of the pet is also provided within the electronics compartment 24 and is interfaced to the processor 48. All electronic components of the GPS compartment 22 and the electronics compartment 24 are preferably powered by a replaceable, rechargeable Li-Ion battery connection 56, via charging circuit and power supply 57 and charging contacts 25. The battery is designed to be replaceable after a long period of use and rechargeable on a continuous basis.

Key to the operation of the pet containment system 10 is the main microcontroller 48. The main microcontroller 48 handles all operations of closed loop monitoring of states and acquisition of the current position of the collar on a continuous basis. The main microcontroller 48 also receives and operates on user-interface instructions entered via switches 32a and 32b.

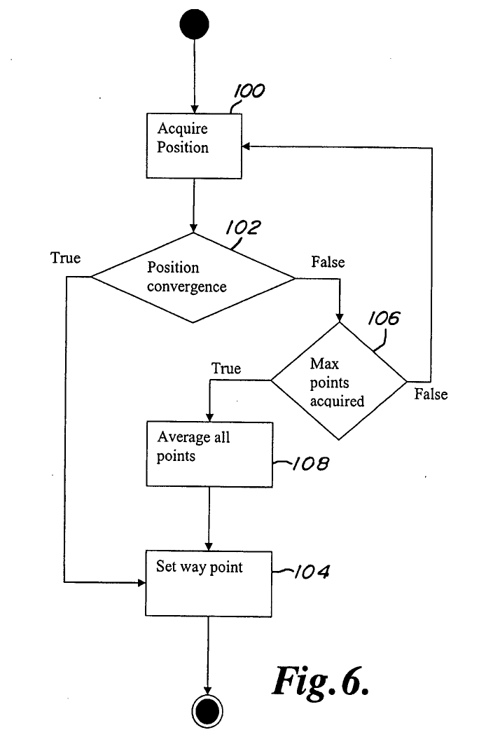

The current position of the collar 20 is acquired according to the flow chart of FIG. 6. The GPS provides multiple readings to the main microcontroller 48, per process block 100. The microcontroller 48 then queries, whether, based on the GPS data, position convergence has occurred, per decision block 102. If position convergence has occurred, a way point is set per process block 104. If position convergence has not occurred, the menu processor queries whether the maximum number of GPS position data points have been acquired to determine position convergence, per decision block 106. If not, additional data points are acquired, per process block 100. If enough data points have been acquired, the data points are averaged, per process block 108, and the way point is set, per operations block 100. Operational flow is then returned to the main loop, described in further detail below.

Firmware—Main Loop

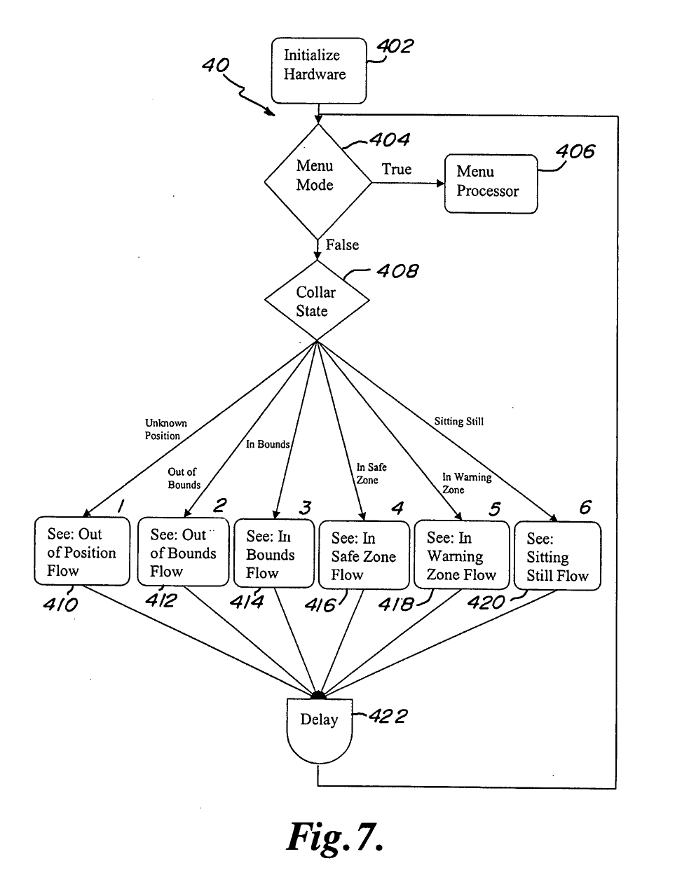

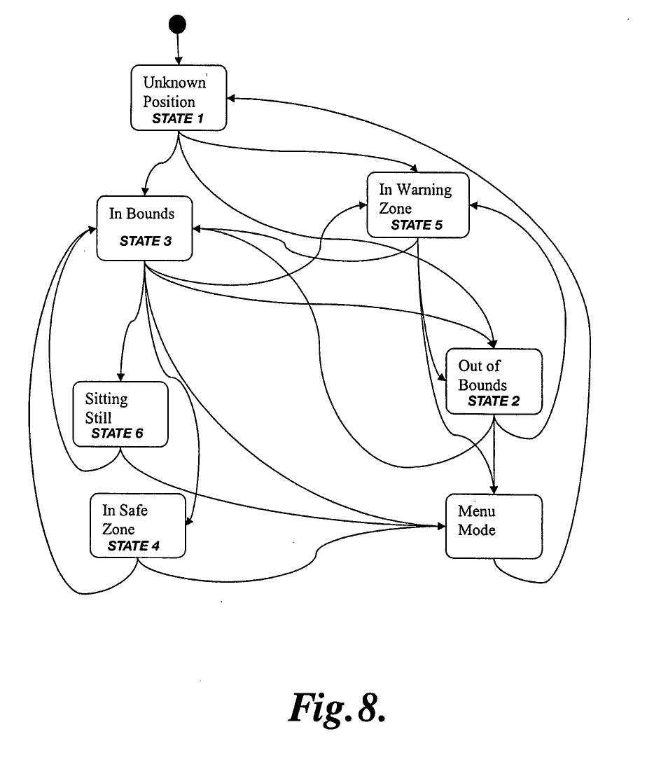

The main microcontroller 48 is loaded with a firmware program to provide the pet containment system 10 with the operation detailed in the flow charts of FIGS. 6-7 and 9-18. The main loop 40 of the pet containment program is depicted in FIG. 7. Upon the first use and the powering up of the pet collar 20 or the hardware of the system is initialized, per process block 402, and the electronic components of the collar 20 determine whether the collar is in menu mode, per decision block 404. If the collar 20 is in menu mode, operation is transferred to the menu processor logic, per process block 406. If the collar 20 is not in menu mode, a query is made as to the state of operation of the collar, per decision block 408. The collar is provided with at least six states of operation, including: State 1.) Unknown Position, in which case the program follows the “out of position” flow, per process block 410; State 2.) Out of Bounds, in which case the program follows the “Out of Bounds” flow, per process block 412; State 3.) In Bounds, in which case the program follows the “In Bounds” flow, per process block 414; State 4.) In Safe Zone, in which case the program follows the “In Safe Zone” flow, per process block 416; State 5.) In Warning Zone, in which case the program follows the “In Warning Zone flow, per process block 418; and State 6.) Sitting Still, in which case the program follows the “Sitting Still” flow, per process block 420. Then, after a delay 422, the operational closed loop of the program returns to the menu mode query, per decision block 404.

FIG. 8 is a collar state transition diagram showing the various states that each of the six identified states may transition to. Unknown Position, which is state 1, may transition to In Bounds (state 3), Out of Bounds (state 2), or In Warning Zone (state 5). In Bounds, which is state 3, may transition to Sitting Still (state 6), In Safe Zone (state 4), In Warning Zone (state 5), Out of Bounds (state 2), or to Menu Mode. Sitting Still, which is state 6, may transition to In Bounds (state 3) or to Menu Mode. In Safe Zone, which is state 4, may transition to In Bounds (state 3) or to Menu Mode. In Warning Zone, which is state 5, may transition to In Bounds (state 3), Out of Bounds (state 2), or to Menu Mode. Out of Bounds, which is state 2, may transition to In Bounds (state 3), In Warning Zone (state 5), or to Menu Mode. Menu Mode may transition to Unknown Position (state 1).

A. Menu Mode—Menu Processor Logic

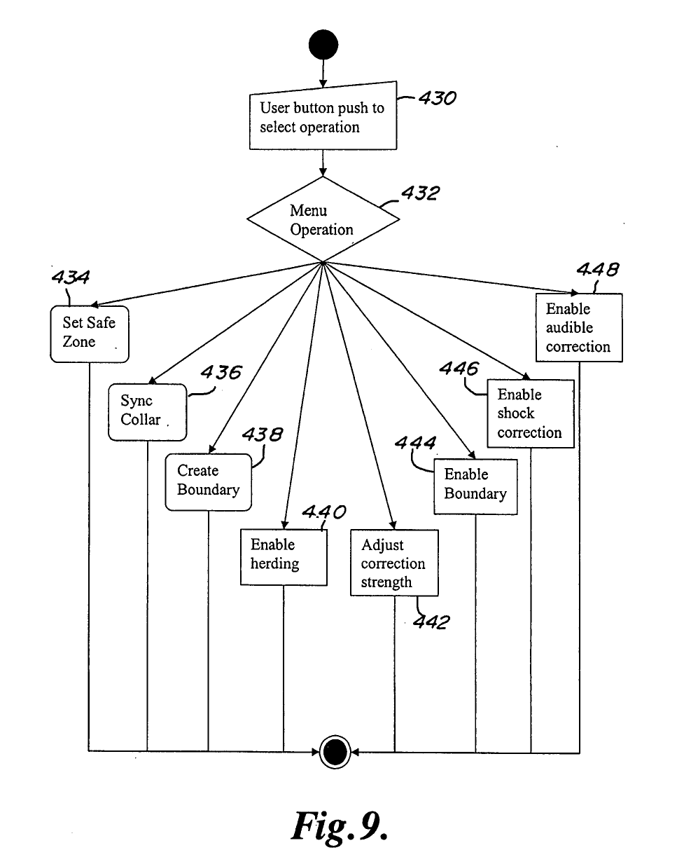

Menu mode transfers operation of the collar to the menu processor logic and allows the user to established desired operational parameters of the collar. The user button provided on the component housing of the collar enables the user to select from a number of options, per input block 430, when in Menu Mode as diagrammed in FIG. 9. These options include, per decision block 432, but are not limited to: 1.) Set Safe Zone, per process block 434; 2.) Sync Collar, per process block 436; 3.) Create Boundary, per process block 438; 4.) Enable Herding, per process block 440; 5.) Adjust Correction Strength, per process block 442; 6.) Enable Boundary, per process block 444; 7.) Enable Shock Correction, per process block 446; and 8.) Enable Audible Correction, per process block 448. After utilizing menu operations, flow of the program of the collar returns to the main loop, see FIG. 7.

A. i. Menu Processor Logic—Set Safe Zone

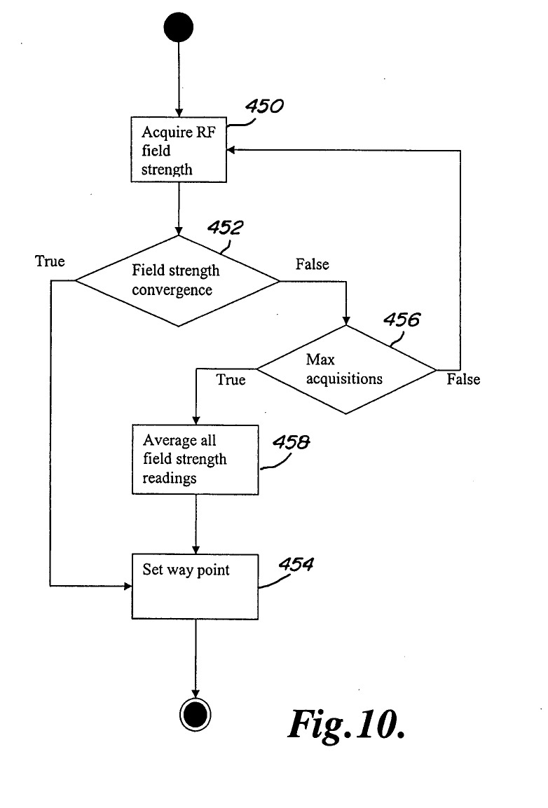

Menu mode, via functionality of the menu processor, allows the user to Set a Safe Zone. The safe zone is calculated automatically based on radio frequency (RF) field strength. FIG. 10 diagrams how the safe zone is calculated. Initially, per process block 450, a reading of the RF field strength is acquired. The menu processor then queries whether there is field strength convergence, per decision block 452. If there is a field strength convergence, the way point is set, per operations block 454. If there is no field strength convergence, the menu processor queries whether the maximum number of field strength data points has been acquired, per decision block 456. If not, additional data points are acquired, per process block 450. If enough data points have been acquired, the menu processor operates to average all of the field strength readings, per process block 458 and sets the way point according thereto, per process block 454.
A. ii. Menu Processor Logic—Synchronize Position

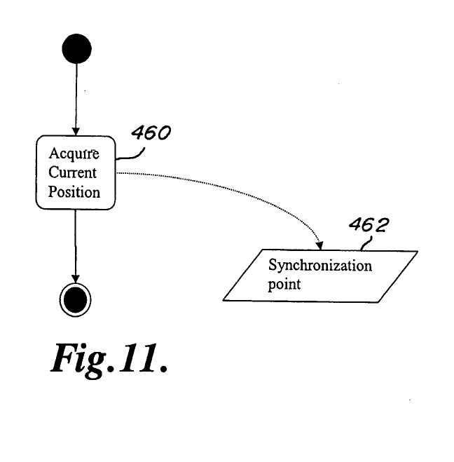

As noted above, an additional function performed by the menu processor is obtaining a synchronization point. The synchronization point is obtained according to the flow chart of FIG. 11. As shown, the current position is acquired, in accordance with the flow chart of FIG. 6, per process block and that position is output and stored as the synchronization point for later use, per data block 462.
A. iii. Menu Processor Logic—Create Boundary

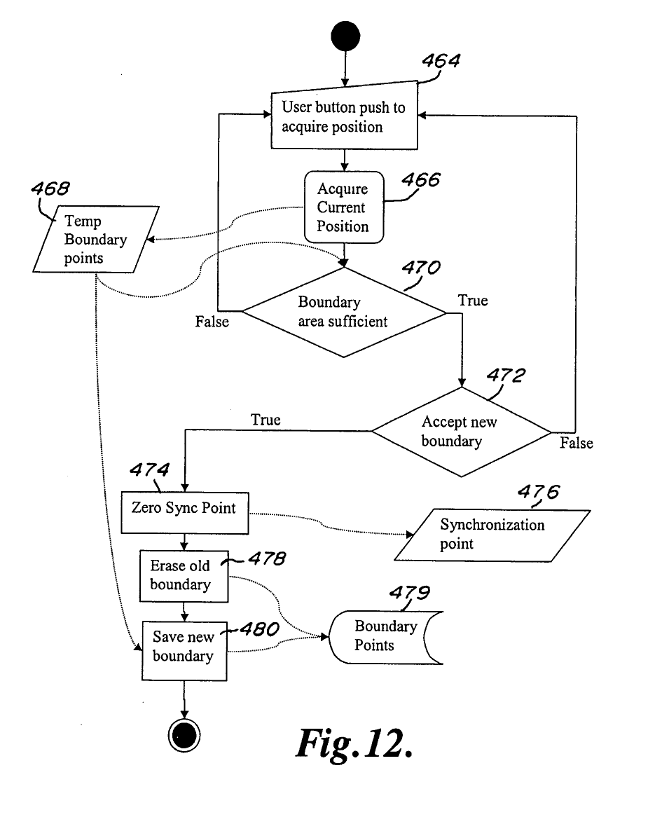

A boundary may be created, via menu mode and the menu processor logic, in accordance with the flow chart of FIG. 12. As diagrammed, a boundary is created by the user first requesting, through push button action of the membrane switches (manual input block 464), that the collar 20 acquire its current position in accordance with the flow chart of FIG. 6, per process block 466. The current position is stored as a temporary boundary point, per data block 468. The menu processor then queries whether based on the temporary boundary points if the boundary area is sufficient, e.g., query, have enough temporary boundary points been entered to define an area, per decision block 470. If not, the user may move the collar to a new location and once again acquire its current position to be stored as a temporary boundary point.

If the boundary area is sufficient, the menu processor queries the user as to whether the new boundary should be accepted, per decision block 472. If the boundary area is not accepted by the user, the user may once again attempt to create a boundary by acquiring current positions of the collar for storage as temporary boundary points. If the boundary area is accepted by the user, a zero sync point is set, per process block 474 and it is stored as the synchronization point, per data block 476. Next the old boundary points are erased from memory, per process block 478 and stored data block 479, and the temporary boundary points are saved as the new permanent boundary points, per process block 480 and stored data block 479.
A. iv. Menu Processor Logic—Enable/Disable and Adjustments

The user is provided the option to enable or disable certain collar settings through the push of a button. Specifically, the user is provided with the option to enable/disable herding, enable/disable the created boundary, enable/disable a shock correction delivered through the collar to the pet, and enable/disable an audible warning delivered through the collar. Additionally, the user is provided with the ability to increase/decrease the amount of shock correction delivered to the pet via the collar through the push of a button.

B. Collar State 1—Unknown Position

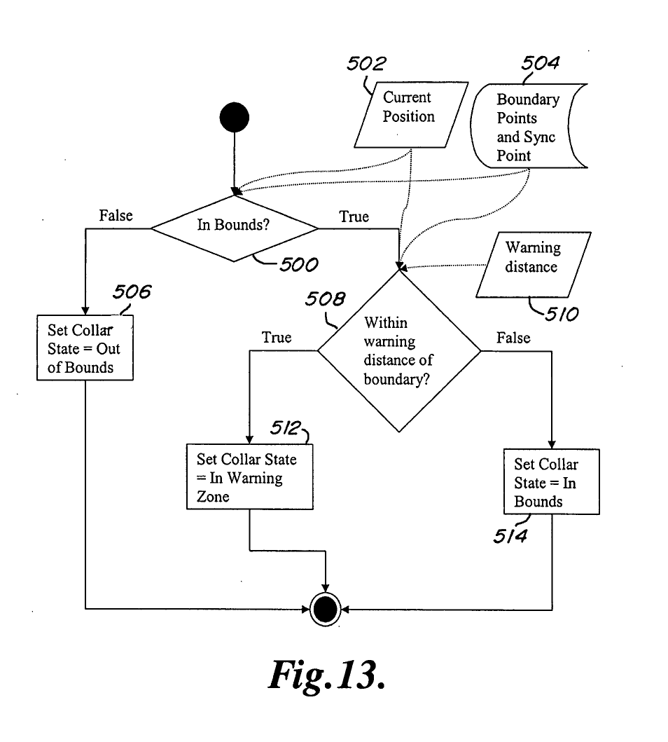

FIG. 13 diagrams the operational flow of the program when the dog collar is in state 1, Unknown Position. As shown, the flow begins with a query, per decision block 500, as to whether the collar is in bounds. The determination as to whether the collar is in bounds is made according to the current position, per data block 502, and the previously established data of boundary points and sync point, per stored data block 504. If the collar is not in bounds, the state of the collar is set to Out of Bounds (state 2), per process block 506, and flow of the program is returned to the main loop, see FIG. 6. If the collar is in bounds, a query is posed as to whether the collar is within a warning distance of the boundary, per decision block 508. The determination as to whether the collar is within a warning distance of the boundary is made according to the current position, per data block 502, established data of boundary points and sync point, per stored data block 504, and warning distance, per data block 510. If the collar is within a warning distance of the boundary, the collar state is set to In Warning Zone (state 5), per process block 512. If the collar is not within a warning distance of the boundary, the collar state is set to In Bounds (state 4), per process block 514.

C. Collar State 2—Out of Bounds

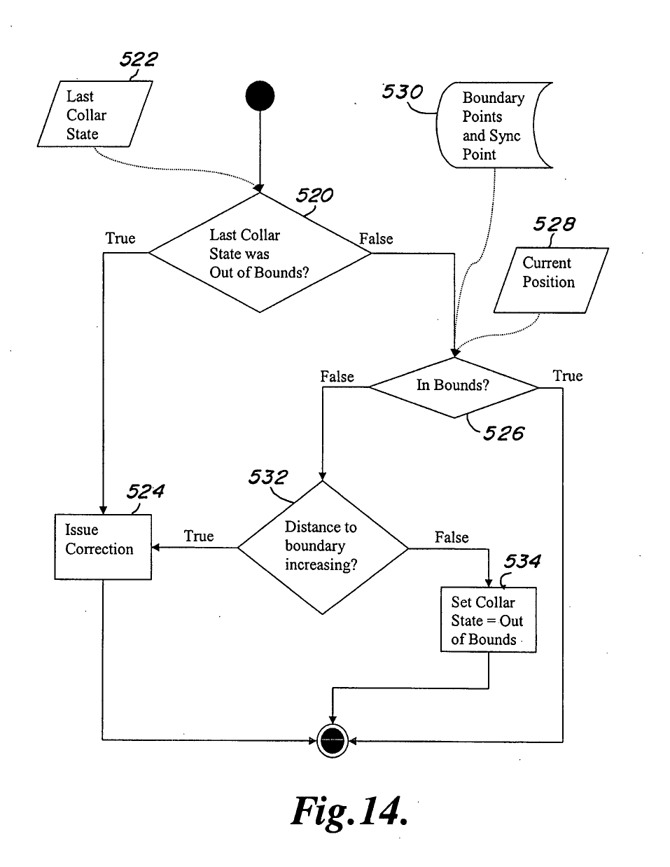

FIG. 14 diagrams the operational flow of the program when the dog collar is in state 2, Out of Bounds. As shown, the flow begins with a query, per decision block 520, as to whether the last collar state was Out of Bounds as indicated by the last collar state data, per data block 522. If the last collar state was Out of Bounds, a correction is issued to the pet through the collar either by a shock correction that has been user enabled or by an audible correction that has been user enabled, per process block 524. If the last collar was not Out of Bounds, a query is issued to determine whether the collar is In Bounds, per decision block 526. The determination as to whether the collar is In Bounds is made using the current position of the collar, per data block 528, and the boundary points and sync point, per stored data block 530. If the collar is In Bounds, flow of the program is returned to the main loop. If the collar is not In Bounds, a query is issued as to whether distance to the created boundary is increasing, per decision block 532. If the distance to the boundary is indeed increasing, a correction is issued through the collar, per process block 524. If the distance to the boundary is not increasing, the collar state is set to Out of Bounds (state 2), per process block 534 and operation is returned to the main loop.

D. Collar State 3—In Bounds

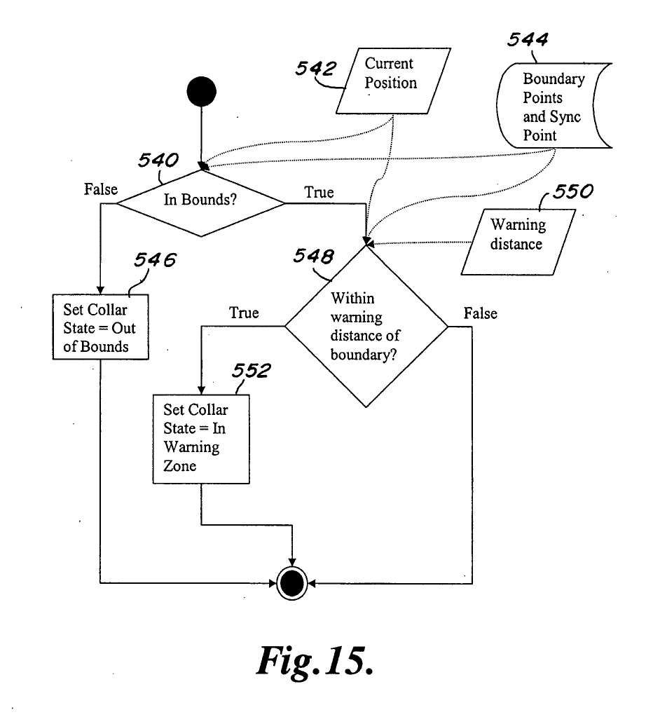

FIG. 15 diagrams the operational flow of the program when the dog collar is in state 3, In Bounds. As shown, the flow begins with a query, per decision block 540, as to whether the collar is In Bounds. A determination as to whether the collar is In Bounds is made according to the current position, per data block 542, the created boundary points and sync point, per stored data block 544. If the collar is not In Bounds, the state of the collar is set to Out of Bounds (state 2), per process block 546 and operation is returned to the main loop. If the collar is In Bounds, then a query is issued to determine if the collar is within a warning distance the boundary, per decision block 548. A determination as to whether the collar is within warning distance of the boundary is made according to the current position, the boundary points and sync point, and the warning distance, a pre-programmed distance per data block 550. If the collar is within warning distance of the boundary, the state of the collar is set to In Warning Zone (state 5), per process block 552, and operation is returned to the main loop. If the collar is not within warning distance of the boundary, no action is taken and operation is returned to the main loop.

E. Collar State 4—In Safe Zone

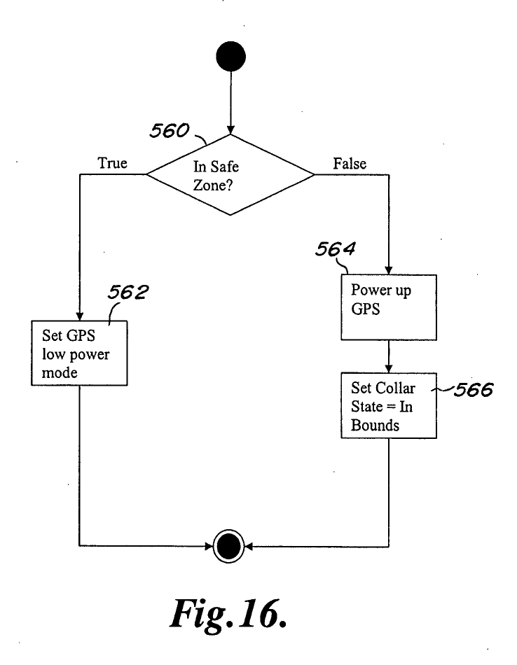

FIG. 16 diagrams the operational flow of the program when the dog collar is in state 4, In Safe Zone. As shown, the flow begins with a query, per decision block 560, as to whether the collar is In Safe Zone. If the collar is In Safe Zone, the GPS is set to a low power mode, per process block 562, to conserve battery life. If the collar is not In Safe Zone, the GPS is powered up, per process block 564 and the state of the collar is set to In Bounds, per process block 566. Operation is then returned to the main loop.

F. Collar State 5—In Warning Zone

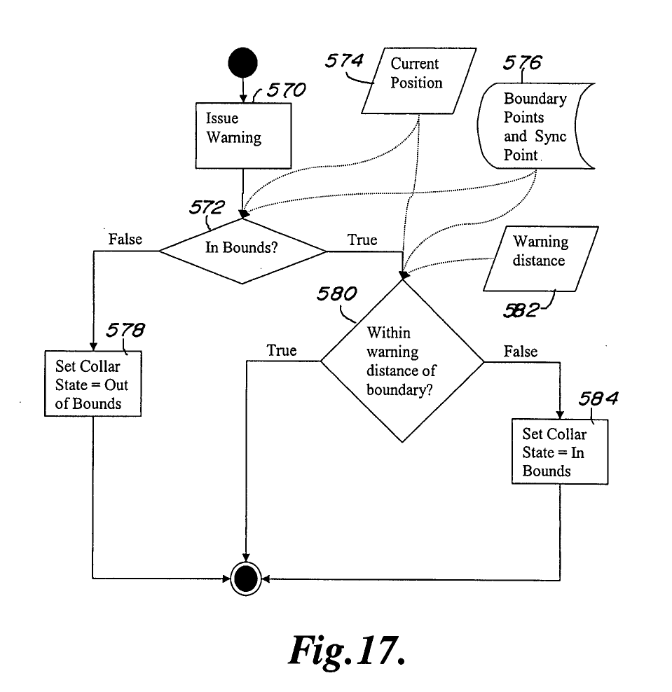

FIG. 17 diagrams the operational flow of the program when the dog collar is in state 5, In Warning Zone. As shown, the flow begins with the operation of issuing a warning to the pet through the collar, i.e. either with a shock or audible alarm, per process block 570. Next, a query is issued, per decision block 572, as to whether the collar is In Bounds. A determination as to whether the collar is In Bounds is made according to the current position, per data block 574, the created boundary points and sync point, per stored data block 576. If the collar is not In Bounds, the state of the collar is set to Out of Bounds (state 2), per process block 578 and operation is returned to the main loop. If the collar is In Bounds, then a query is issued to determine if the collar is within a warning distance the boundary, per decision block 580. A determination as to whether the collar is within warning distance of the boundary is made according to the current position, the boundary points and sync point, and the warning distance, a pre-programmed distance per data block 582. If the collar is not within warning distance of the boundary, the state of the collar is set to In Bounds (state 3), per process block 584, and operation is returned to the main loop. If the collar is within warning distance of the boundary, no action is taken and operation is returned to the main loop.

G. Collar State 6—Sitting Still

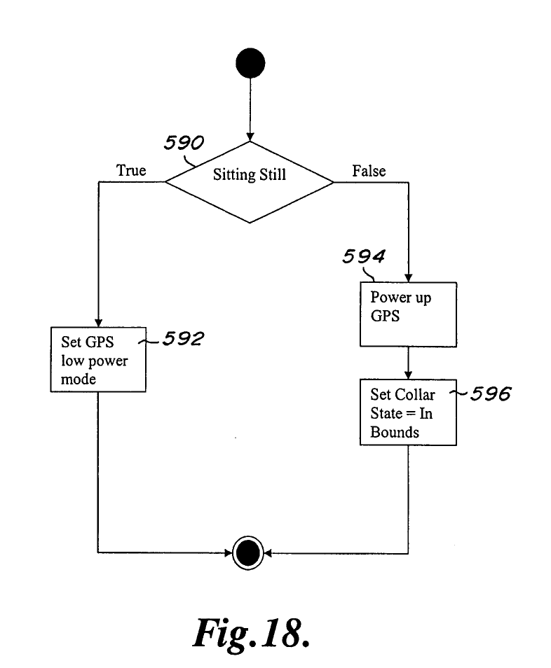

FIG. 18 diagrams the operational flow of the program when the pet collar is in state 6, Sitting Still. As shown, the flow begins with a query as to whether the collar is still, per decision block 590. The determination as to whether the collar is motion or still is made via signal feedback from the accelerometer; the signal strength of the accelerometer indicates motion or stillness. If the collar is in a still position, the GPS is set to a lower power mode to conserve battery power, per process block 592. Operation is then returned to the main loop. If the collar is in motion, the GPS is powered up and the state of the collar is set to In Bounds, per process blocks 594 and 596, respectively. Operation is then returned to the main loop.

User Interface Menu Options

In accordance with the operation described above, the user is presented with an LCD menu 34 and two membrane switches 32a, 32b for entering desired operation parameters. The main menu options are itemized as numbers 1-6 in the menu listing below while sub-options within that main menu option are also listed.

Main Menu Listing

| | |
|---|---|
| 1. | Re-sync Boundary |

Go To Sync Location and Press Right Button
Acquiring Sync Position |-----------| (bar chart provides

indication of progress)

Cancel or Finish Sync

| | |
|---|---|
| 2. | Create Boundary |

Add Boundary Point #1 |-----------|, #2, #3 (bar chart

provides indication of progress)

Boundary Insufficient (until at least 3 points entered,

then options changes to:

Finish New Boundary (will erase old boundary))

Cancel Boundary
Cancel Point

| | |
|---|---|
| 3. | Collar Enabled |

Yes/No

| | |
|---|---|
| 4. | Select Correction |

Audible Correction On/Off
Shock Correction On/Off
Shock Strength |-----------| (bar chart provides indication

of strength)

Main Menu

| | |
|---|---|
| 5. | Set Safe Zone |

Set Safe Zone Radius
Setting Safe Zone |-----------| (bar chart provides indication

of establishing setting)

Finish Setting Safe Zone

Main Menu

| | |
|---|---|
| 6. | Quit |

Example Set-Up of GPS Pet Containment System

The following is an example of an initial set up sequence of the GPS Pet Containment System of the present invention, departures from the sequence may be used without departing from the spirit or scope of the invention.

Initially the collar 20 is placed within the recharge cradle 21 for charging of the collar battery. Once charged, the collar is completely, self-contained system for both set-up and operation of the collar. All operating parameters are entered through the collar itself and all operational control systems are provided within the collar itself. The first step in set-up of the collar is establishment of the sync point. The user goes to the location where they wish to establish their “GPS fence” and acquires the GPS sync point which identifies an initial position/location, via menu selection one. The next step, is for the user to establish their “GPS fence”. The user walks about the desired “GPS fence” perimeter with the collar and identifies preferably three or more way points about the perimeter, through menu selection two. A selection of less than three way points will provide the user with an indication of an insufficient boundary on the LCD menu, three or more points will provide the user with the option to finish the boundary, cancel the boundary or cancel a point.

Presuming the user has finished the boundary, resulting in any previous boundary being deleted, the user may then enable the collar, through menu option three. Enabling the collar allows the collar to move into active operation and to deliver corrections that have been selected by the user. The corrections that may be set by the user, via LCD menu option four include activating/deactivating an audible alarm and activating/deactivating a shock alarm. As an alternative embodiment, a vibrational alarm may also be selected. The user also has the option of selecting the level of shock that is delivered to the animal, through menu option four.

In a preferred embodiment the user is also provided with the ability to enable/disable a herding function of the collar. This is a function unique to the present invention. With typical wire, underground fences, the containment system has no way of knowing if the animal that is crossing the perimeter is crossing to reenter the containment area or is crossing to exit the containment area. Either way, the animal would likely be shocked when crossing the perimeter. When enabled in the present invention, the herding function utilizes the functionality of the system's accelerometer to determine relative motion of the collar. Specifically, during the time between GPS updates, which typically occur only once per second, the accelerometer is used to provide dead reckoning position information. This is accomplished by integrating the acceleration value (G forces measured on X, Y, and Z axis) over sub-second time intervals. This results in the distance and relative heading to previous sub-second time intervals. Thus, the collar can determine which direction the animal is moving relative to past movements. If it is determined the animal is moving back into its containment perimeter, no shock is provided, if it is determined the animal is moving away from its containment perimeter the shock is provided.

The final element in the set up of the GPS pet containment system of the present invention is to set a safe zone, per menu option 5. When the user selects to establish a safe zone, from the current position, the main microprocessor averages the strength of the RF signal, which is being emitted by the RF transmitter of the cradle and received by the RF receiver in the collar, over time (the RSSI provides the power perceived) and formulates an RF bubble about the containment area. This RF bubble or safe zone can now be used for power saving features of the collar and GPS pet containment system. It should be noted that the establishment of a safe zone and the use of the RF signal from the cradle is not required for the operation of the collar. It is an enhancement to the collar operation, providing it with a power saving feature. However, it should be noted that the collar itself is a completely, operationally independent element with all parameters and control be handled through the collar itself.

Power Saving Features

An indication of a strong RF signal indicates that the collar is within close proximity to the cradle and is also within its perimeter/boundary. As such, GPS data collection is not necessary. When GPS tracking is not required, the microcontroller itself can manage clock speeds and sleep states to minimize the current consumption. Additionally, the accelerometer has a low power comparator that provides an interrupt drive motion detector which can be used to turn off both the RF and GPS systems, i.e., the pet is sitting/laying still, no motion is occurring, no need to waste power consumption for RF field strength monitoring or GPS tracking.

Additional Features

The GPS pet containment system of the present invention is a independent self-contained system, utilizing a single GPS, requiring no additional external elements for operation. However, additional elements may be added to further enhance operation. For instance, the system could additionally be provided with location tracking via website or could provide e-mail alerts upon the established boundary being crossed.

Alternative Uses

The invention described herein has been described with reference to a pet containment application. However, it should be noted that the technology of the present invention could be utilized in alternative applications. For instance, the technology could be used in the sport dog industry where instead of selecting way points, a radius, e.g., 1 mile, is established about the initial location of the dog and the user is provided with the RF transmitter. The technology could also be used to monitor the location of horses, cattle, or equipment. Moreover, the technology could be used in prisoner containment to signal a broken barrier or as a personal safety product for a human user.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

What is claimed:

1. A GPS pet containment system, comprising:
a collar, wherein said collar includes a battery power source, a microcontroller powered by said battery power source, a global positioning system (GPS) interfaced to said microcontroller and an accelerometer interfaced to said microcontroller;
wherein said GPS provides collar location information on a periodic basis and wherein said accelerometer provides collar dead reckoning location information on a substantially continuous basis by integrating the acceleration value provided by said accelerometer over sub-second time intervals.

2. The GPS pet containment system of claim 1, wherein the integration of the acceleration value provided by said accelerometer over sub-second time intervals results in a distance value and a relative heading to previous sub-second time intervals.

3. The GPS pet containment system of claim 1, wherein the elements of said system are independently and completely contained within the confines of the collar.

4. The GPS pet containment system of claim 1, further comprising a recharging cradle, wherein said recharging cradle releasably accepts and supports said collar, and recharges said battery power source.

5. The GPS pet containment system of claim 1, wherein the accelerometer provides an indication of no motion of said collar, and wherein said indication is used to turn off the GPS to preserve battery power.

6. A GPS pet containment system, comprising:
a collar, wherein said collar includes a battery power source, a microcontroller powered by said battery power source, a global positioning system (GPS) interfaced to said microcontroller and an RF receiver/transmitter interfaced to said microcontroller; and
a cradle, wherein said cradle includes an RF receiver/transmitter, and wherein said cradle RF receiver/transmitter emits a signal to create an RF bubble about said collar, wherein said RF bubble is defined by a signal strength detected by said collar RF receiver/transmitter, and upon detecting that signal strength is strong, GPS tracking is ceased to conserve battery power.

7. The GPS pet containment system of claim 6, further comprising an accelerometer interfaced to said microcontroller, wherein said GPS provides collar location information on a periodic basis and wherein said accelerometer provides collar dead reckoning location information on a substantially continuous basis by integrating the acceleration value provided by said accelerometer over sub-second time intervals.

8. The GPS pet containment system of claim 7, wherein the integration of the acceleration value provided by said accelerometer over sub-second time intervals results in a distance value and a relative heading to previous sub-second time intervals.

9. The GPS pet containment system of claim 8, wherein the accelerometer provides an indication of no motion of said collar, and wherein said indication is used to turn off the GPS to preserve battery power.

10. The GPS pet containment system of claim 6, wherein said cradle releasably accepts and supports said collar, and recharges said battery power source.

11. The GPS pet containment system of claim 6, wherein said collar comprises a stainless steel band supporting at least two electronic housings, wherein said electronic housings are connected by a flexwire, and wherein said electronic housings, said steel band, and said flexwire are overmolded to form a single unit.

12. The GPS pet containment system of claim 11, wherein said collar is overmolded with saniprene.

13. A GPS pet containment system, comprising:
a collar, wherein said collar includes a battery power source, a microcontroller powered by said battery power source, a global positioning system (GPS) interfaced to said microcontroller and an accelerometer interfaced to said microcontroller;
wherein said GPS provides collar location information on a periodic basis and wherein said accelerometer provides collar dead reckoning location information on a substantially continuous basis by integrating the acceleration value provided by said accelerometer over sub-second time intervals, wherein said collar dead reckoning location information determines whether the collar is leaving a boundary or returning to a boundary, and wherein said collar delivers a shock to the wearer upon a determination of leaving a boundary.

14. The GPS pet containment system of claim 13, wherein the integration of the acceleration value provided by said accelerometer over sub-second time intervals results in a distance value and a relative heading to previous sub-second time intervals.

15. The GPS pet containment system of claim 13, wherein the elements of said system are independently and completely contained within the confines of the collar.

16. The GPS pet containment system of claim 13, further comprising a recharging cradle, wherein said recharging cradle releasably accepts and supports said collar, and recharges said battery power source.

17. The GPS pet containment system of claim 13, wherein the accelerometer provides an indication of no motion of said collar, and wherein said indication is used to turn off the GPS to preserve battery power.

18. The GPS pet containment system of claim 13, wherein said collar comprises a stainless steel band supporting at least two electronic housings, wherein said electronic housings are connected by a flexwire, and wherein said electronic housings, said steel band, and said flexwire are overmolded to form a single unit.

19. The GPS pet containment system of claim 13, wherein said collar is overmolded with saniprene.
